(19) United States
(12) Patent Application Publication
(10) Pub. No.: US 2007/0214850 A1
(43) Pub. Date: Sep. 20, 2007

(54) Lock assembly

(76) Inventor: Min-Tsung Ma, Chang Hua County (TW)

Correspondence Address: BROWDY AND NEIMARK, P.L.L.C.;624 NINTH STREET, NW, SUITE 300, WASHINGTON, DC, 20001-5303, US

(21) Appl. No.: 11/374,002

(22) Filed: Mar. 14, 2006

(51) Int. Cl. E05B 37/00

(52) U.S. Cl. 70/284

(57) ABSTRACT

A lock assembly includes a casing accommodating therein a combination lock and a pin tumbler lock. The combination lock has a set of numbered wheels and a lifting plate vertically movable relative to the numbered wheels. The pin tumbler lock has a plug rotatable between a locked position and an unlocked position. The plug has an actuating block which stops at the lifting plate when the plug is in the locked position and moves the lifting plate away from the numbered wheels when the plug is moved from the locked position to the unlocked position.

### BACKGROUND OF THE INVENTION

1. Field of the Invention

The present invention relates to locks and more particularly, to a lock assembly, which is the combination of a combination lock and a pin tumbler lock.

2. Description of the Related Art

Conventional locks mainly include two types, namely, the combination lock operatable by a plurality of numbered wheels and the pin tumbler lock operatable by a key. If a suitcase uses a combination lock, the user must rotate the numbered wheels of the combination lock to show the correct combination when wishing to open the suitcase. If a suitcase uses a pin tumbler lock, the user must insert the correct key into the keyway of the pin tumbler lock and then rotate the plug of the pin tumbler lock with the key to the unlocking position when wishing to open the suitcase.

If a suitcase uses a combination lock and the user forgets the correct combination of the combination lock, the user must deliver the suitcase to the distributor or a locksmith to open the combination lock. If a suitcase uses a pin tumbler lock and the user does not have the key in hand, the user still cannot open the suitcase.

Further, in order to prevent a terrorist attach, customs clerks may have to check suitcases and luggage. When checking a suitcase that uses a combination lock, the customs clerk must destroy the suitcase so that the content of the suitcase can be seen. In this case, a dispute may arise between the customs clerk and the passenger.

### SUMMARY OF THE INVENTION

The present invention has been accomplished under the circumstances in view. It is the main object of the present invention to provide a lock assembly, which is the combination of a combination lock and a pin tumbler lock and can be conveniently opened by selectively using the numbered wheels of the combination lock or the key of the pin tumbler lock.

To achieve this object of the present invention, the lock assembly comprises a casing, a combination lock and a pin tumbler lock mounted respectively in the casing. The combination lock has a plurality of numbered wheels and a lifting plate movable relative to the numbered wheels. The pin tumbler lock has a plug rotatable between a locked position and an unlocked position. The plug has an actuating block which stops at the lifting plate when the plug is in the locked position and moves the lifting plate away from the numbered wheels when the plug is moved from the locked position to the unlocked position.

### BRIEF DESCRIPTION OF THE DRAWINGS

FIG. 1 is an exploded view of a lock assembly according to a preferred embodiment of the present invention.

FIG. 2 is a schematic top view of the lock assembly according to the preferred embodiment of the present invention.

FIG. 3 is a sectional view of the preferred embodiment of the present invention, showing positions of the lifting plate and the sliding plate after unlocking of the combination lock.

FIG. 4 is a sectional view of the preferred embodiment of the present invention, showing positions of the lifting plate and the sliding plate after locking of the combination lock.

FIG. 5 is similar to FIG. 2 but showing the status of the lock assembly after unlocking of the pin tumbler lock.

FIG. 6 is similar to FIG. 4 but showing the status of the lock assembly after unlocking of the pin tumbler lock.

### DETAILED DESCRIPTION OF THE INVENTION

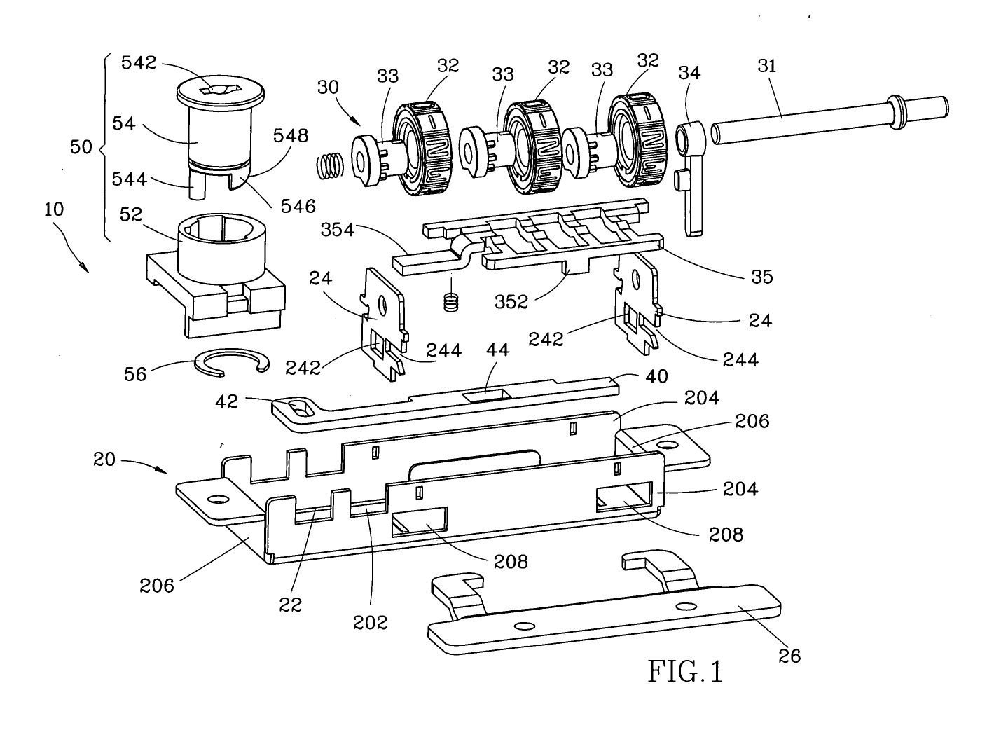

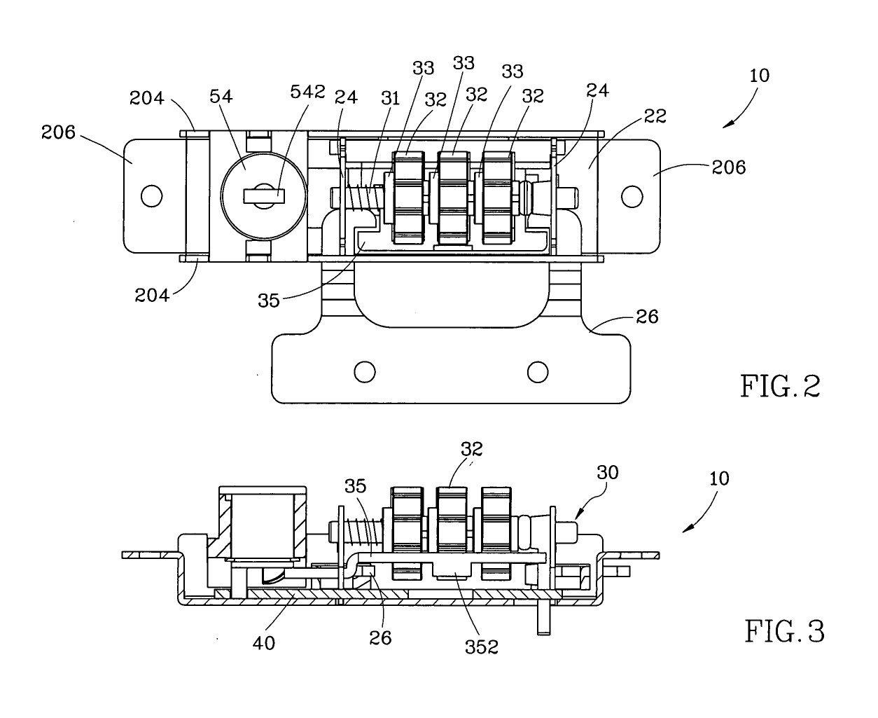

As shown in FIGS. 1 and 2, a lock assembly 10 in accordance with the preferred embodiment of the present invention comprises a casing 20, a combination lock 30, a sliding plate 40, and a pin tumbler lock 50.

The casing 20, which can be firmly fastened to a half shell (not shown) of a suitcase or a luggage, comprises a flat rectangular bottom wall 202, two first sidewalls 204 respectively perpendicularly extending from the two opposite long sides of the flat rectangular bottom wall 202, two second sidewalls 206 respectively perpendicularly extending from the two opposite short sides of the flat rectangular bottom wall 202 and respectively fixedly connected between the first sidewalls 204. The flat rectangular bottom wall 202, the first sidewalls 204 and the second sidewalls 206 define a rectangular receiving open chamber 22. Two locating plates 24 are fixedly mounted inside the rectangular receiving open chamber 22 in vertical posture and arranged in parallel. Each of the locating plates 24 has a through hole 242 and a locating notch 244. The casing 20 further has two openings 208 formed in one first sidewall 204 for insertion of two hooks of a locking bar 26 that can be firmly fastened to another half shell (not shown) of a suitcase or a luggage.

The combination lock 30 comprises a shaft 31, three numbered wheels 32 mounted on the shaft 31, three actuating wheels 33 respectively mounted in the numbered wheels 32 and supported on the shaft 31, a lever 34 supported on the shaft 31 and coupled to one of the actuating wheels 33, and a lifting plate 35 for supporting the numbered wheels 32 and the actuating wheels 33. The lifting plate 35 is engagable with the hooks of the locking bar 26 when the locking bar 26 is inserted into the casing 20 through the openings 208. The combination lock 30 is installed in the receiving open chamber 22 of the casing 20 by means of inserting two distal ends of the lifting plate 35 into the through holes 242 of the locating plates 24. Further, the lifting plate 35 has a butt 352 at the bottom side and a stop rod 354 at one end. Rotating the numbered wheels 32 can cause a vertical movement of the lifting plate 35 relative to the numbered wheels 32. When the numbered wheels 32 are aligned to show the correct combination, the combination lock 30 is opened, i.e. the locking bar 26 can be moved away from the lifting plate 35.

The sliding plate 40 is moveably mounted in the receiving open chamber 22 of the casing 20 and coupled to the locating notches 244 of the locating plates 24. The sliding plate 40 has an oval insertion slot 42 cut through the top and bottom walls thereof at one end, and a rectangular through hole 44 cut through the top and bottom walls on the middle thereof.

The pin tumbler lock 50 comprises a plug holder 52 fixedly mounted in the receiving open chamber 22 of the casing 20, and a plug 54 inserted through the plug holder 52 and secured thereto by a C-shaped retainer 56. The plug 54 can be rotated with the key (not shown) relative to the plug holder 52 between a locking position and an unlocking position. The plug 54 has a keyway 542 in the top side for the insertion of the key, a bottom pin 544 inserted through the insertion slot 42 of the sliding plate 40, and a bottom actuating block 546, which has a beveled actuating face 548 stopped against the stop rod 354 of the lifting plate 35 of the combination lock 30. When the user inserting the key into the keyway 542 to rotate the plug 54 to the unlocking position, the sliding plate 40 will be moved toward the combination lock 30 by the bottom pin 544, and at the same time the stop rod 354 of the lifting plate 35 of the combination lock 30 will be forced by the actuating block 546 to lower the lifting plate 35 relative to the numbered wheels 32, thereby forcing the butt 352 into the rectangular through hole 44 of the sliding plate 40. When the pin tumbler lock 50 is in the locking position, the actuating block 546 is stopped against the stop rod 354 of the lifting plate 35 of the combination lock 30, and the butt 352 is disengaged from the rectangular through hole 44 of the sliding plate 40.

Referring to FIG. 3, when the lock assembly 10 is used in a suitcase (not shown) and the user wishes to open the suitcase by means of the combination lock 30, the user must rotate the numbered wheels 32 to show the correct combination so as to further unlock the combination lock 30. When the combination lock 30 is unlocked, the butt 352 is kept away from the rectangular through hole 44 of the sliding plate 40, the lifting plate 40 and the locking bar 26 are in a staggered manner, and the lifting plate 35 is suspending above the locking bar 26.

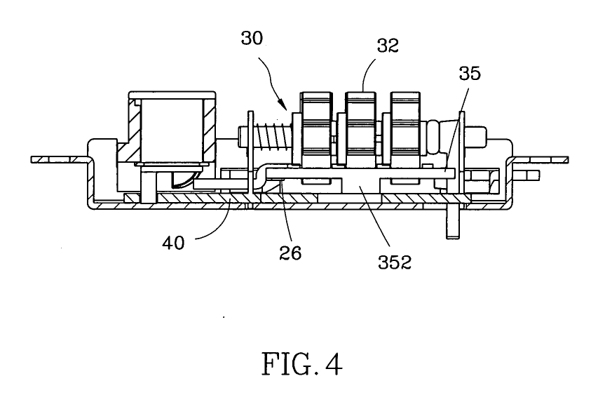

Referring to FIG. 4, when the user rotating the numbered wheels 32 to lock the combination lock 30, the lifting plate 35 will be lowered relative to the numbered wheels 32 to the same elevation of the locking bar 26 so that the locking bar 26 can not be moved out of the casing 20 due to the interference of the lifting plate 35.

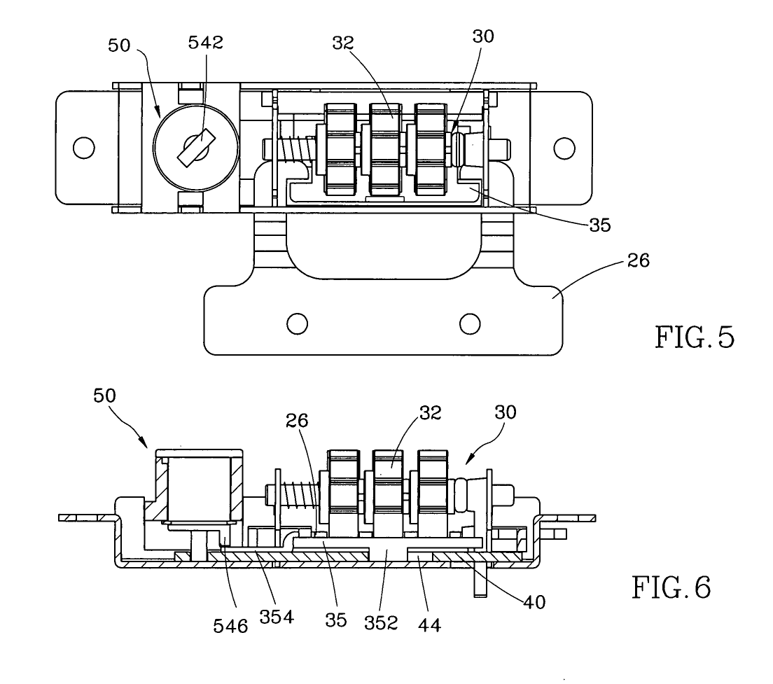

Referring to FIGS. 5 and 6, if the user cannot remember the correct combination of the combination lock 30 or if the customs clerk wishes to check the content of the suitcase but doesn't know the correct combination of the combination lock 30, the key can be inserted into the keyway 542 of the pin tumbler lock 50 and rotated to move the sliding plate 40 toward the combination lock 30 and to simultaneously force the actuating block 546 against the stop rod 354 of the lifting plate 35 of the combination lock 30, thereby lowering the lifting plate 35 to force the butt 352 of the lifting plate 35 into the rectangular through hole 44 of the sliding plate 40. At this time, the lifting plate 35 and the locking bar 26 are again in a staggered manner, i.e. the lifting plate 35 is kept below the elevation of the locking bar 26; therefore, the hooks of the locking bar 26 can be freely moved away from the openings 208 of the casing 20. This means that the suitcase can be opened.

By means of the linking design of the combination lock 30 and the pin tumbler lock 50, the user can selectively use the combination lock 30 or the pin tumbler lock 50 to open the suitcase. When the customs clerk wishes to check the content of the suitcase, the pin tumbler lock 50 can be operated to open the suitcase even if the combination lock is in the locked manner.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. A lock assembly comprising:
a casing;
a combination lock mounted in said casing, said combination lock having a plurality of numbered wheels and a lifting plate movable relative to said numbered wheels; and
a pin tumbler lock mounted in said casing and provided with a plug rotatable between a locking position and an unlocking position, said plug having an actuating block stopping against said lifting plate for moving said lifting plate away from said numbered wheels when said plug is moved from the locking position to the unlock position.

2. The lock assembly as claimed in claim 1, further comprising a sliding plate mounted inside said casing and coupled to said pin tumbler lock.

3. The lock assembly as claimed in claim 2, wherein said sliding plate has an insertion slot at one end thereof; said plug of the pin tumbler lock has a bottom pin inserted into the insertion slot of said sliding plate for moving said sliding plate in said casing upon rotation of said plug of the pin tumbler lock between said locking position and said unlocking position.

4. The lock assembly as claimed in claim 2, wherein said sliding plate has a through hole; said lifting plate has a bottom butt, said bottom butt being engaged into the through hole of said sliding plate when said plug of the pin tumbler lock is in the unlocked position, said bottom butt being disengaged from the through hole of said sliding plate when said pin tumbler lock is in the locked position.

5. The lock assembly as claimed in claim 4, wherein said lifting plate has a stop rod disposed at one end thereof; said actuating block has a beveled actuating face stopping against the stop rod of said lifting plate when said plug is in the locked position for moving said lifting plate to further force the bottom butt of said lifting plate into the through hole of said sliding plate when said plug is moved from the lock position to the unlocked position.
